(19) United States
(12) Patent Application Publication
(10) Pub. No.: US 2013/0197936 A1
(43) Pub. Date: Aug. 1, 2013

(54) Predictive Healthcare Diagnosis Animation

(71) Applicant: Richard R. Willich, St. Augustine, MD (US)

(72) Inventor: Richard R. Willich, St. Augustine, MD (US)

(21) Appl. No.: 13/364,134

(22) Filed: Feb. 1, 2012

(51) Int. Cl. G06Q 50/22; G06Q 50/24

(52) U.S. Cl. 705/3; 705/2

(57) ABSTRACT

Healthcare expenditures for a given group of individuals are predicted by obtaining healthcare data covering a given group of individuals over a predetermined period of time and processing the obtained healthcare data into a modified healthcare data set. The modified healthcare data set is processed through a plurality of separate analytic algorithms to generate an enriched healthcare data set comprising healthcare treatment outcome data, course of healthcare treatment data and predicted future healthcare costs for the given group of individuals. The enriched healthcare data set is stored in a database and is used to generate and display reports comprising predicted healthcare expenditures for the given groups of individuals. The displayed reports can be animated.

### FIELD OF THE INVENTION

The present invention is directed to predictive analytics.

### BACKGROUND OF THE INVENTION

The ever increasing costs of health care services and the wide range of variables affecting the costs of health care services present a challenge for payers of these health care services or health care premiums including both private and public payers that are looking to predict and to control these costs. Predicting future health care costs allows the payers to develop plans to address or to reduce these predicted future costs. Typically, these future health care cost predictions are generated using models that use diagnoses from claims to risk-adjust health care cost predictions. For example, risk-adjustment models are used to estimate an expected annual cost for each patient to be enrolled in a prepaid health plan. The expected costs for all patients in a given enrollment are summed to yield a total expected annual cost. Historically, deterministic models are used, which are complex and can be difficult to use especially when taking into account interactions among diagnostic groups.

Previously used models also use payer-centric data and limited pharmacy analytics to build the model. Moreover, current models do not incorporate other analytics such as disease identification, gaps in care, disease severity and grouping of episodes. Therefore, a predictive model is needed that is easier to construct and incorporates a broader array of attribute data in providing predictions on future healthcare costs.

### SUMMARY OF THE INVENTION

Exemplary embodiments in accordance with the present invention are directed to systems and methods that provide for the prediction of future healthcare costs for a given group of individuals over a predefined future time horizon, for example one year. The collection, pre-processing, analysis, storage and resultant report creation and display is arranged as a modular pipeline, to facilitate the addition or modification of data pre-processing steps, analytic algorithms, report production and result animation. As the methods and systems of the present invention for predicting future healthcare expenditures utilize a modular approach, new analytic offerings or customer customizations can be accommodated. Healthcare data are obtained from a user or customer. The obtained healthcare data are analyzed for historical healthcare trends and are also used to predict future healthcare expenditures for the individuals associated with the obtained healthcare data. Suitable customers include parties or entities responsible for monitoring or paying healthcare costs or for establishing healthcare plans such as businesses in the payer, third party administrator (TPA), and broker industries.

After the healthcare data are obtained, they are checked for quality and cleaned. For example, errors in the data are identified and removed or corrected. In addition, the obtained data are organized as needed or desired for subsequent processing or consolidation. For example, the obtained customer data is mapped to appropriate categories or groups. In general, the initial pre-processing of the obtained customer healthcare is handled in a data quality service module that can be configured or modified as desired. The modified healthcare data that pass through the data quality service module are then processed through a plurality of separate analytic algorithms. These analytic algorithms include, for example, the industry standard McKesson disease identification, gaps in care and a healthcare cost prediction algorithm.

With regard to gaps in care, gaps are defined in the context of a specific disease state, for example, diabetes. Therefore, the first step is to identify individuals with the disease of interest using a disease identification algorithm such as McKesson disease identification. McKesson's disease identification rules are both clinically sophisticated and flexible in implementation. McKesson's rules distinguish between identifications that are definitive and identifications that are probable to enable intervention to be better focused. The identification rules also take into account clinical practice to reduce false-positives. For example, the rules appropriately handle evaluation and management codes so that they do not identify a patient as definitively having a disease simply because the patient is undergoing evaluation for the disease. McKesson's disease identification rules leverage the full range of encounter data including diagnosis and procedure codes, pharmacy data, and practitioner specialty, making patient evaluation possible using a broader range of data sources. Finally, once a patient has been identified as having a specified disease, exception rules are applied and recorded for that patient. All information regarding gaps in care is available including specifically what rules were used to identify the patient as having the disease and which gaps exist and on what dates.

Since individuals represented in a given set of obtained healthcare data can have unique disease management needs, systems and methods in accordance with the present invention have the capability to apply both McKesson disease identification rules and custom rules to large healthcare data sets. This capability supports customers with large amounts of historical data that are used for benchmarking and also extends disease states and their associated gaps in care beyond those defined by McKesson. In one embodiment, the determination of gaps in care is a two-step process. Systems and methods in accordance with the present invention allow users to see the big picture by tracking at a population level the number of patients with each disease and the compliance level. A root cause analysis is performed by drilling down to the member level to see details related to each individual's gaps related to the disease of interest.

Processing of the modified healthcare data set through the plurality of analytic algorithms results in an analytically enriched data set, which is stored in one or more databases. This analytically enriched data set can then be queried, for example, by the customer from whom the original raw healthcare data where obtained. Based on these queries, ad hoc or standardized reports are generated and displayed. When a sufficient amount of historical healthcare data is provided, the display of the reports includes animation. Animation of historical data, healthcare trends and future predicted healthcare expenditures provides users with greater insight into their healthcare. As additional healthcare data are obtained and processed, the reports are updated.

In accordance with one exemplary embodiment, the present invention is directed to a method for predicting healthcare expenditures. According to this method, obtaining healthcare data covering a given group of individuals over a predetermined period of time. These healthcare data can be obtained, for example, from customers and include cost data associated with claims made to healthcare plans covering individuals in the given group of individuals, demographic data, healthcare plan enrollment data, diagnosis data, chronic disease data, lab result data, electronic medical records, health risk assessments, pharmacy data, genomic data and combinations thereof.

Having obtained the healthcare data, these data are processed into a modified healthcare data set. Processing the obtained healthcare data into the modified healthcare data set further includes creating derivative healthcare attributes from raw data in the obtained healthcare data where the derivative healthcare attributes include a total healthcare cost over the predetermined period of time, a maximum single healthcare cost over the predetermined period of time, an average healthcare cost over the predetermined period of time, a count of single healthcare expenditures above the average healthcare cost, a healthcare cost spike indicator, healthcare cost trends, a healthcare cost period ratio, healthcare costs per individual and combinations thereof. In addition, processing the obtained healthcare data into the modified healthcare data set also includes aggregating national drug codes for pharmacy data in the obtained healthcare data according to the therapeutic class groupings defined in a given pharmacy reference, aggregating diagnostic data in the obtained healthcare data according to the international classification of diseases, ninth revision, clinical modification or aggregating diagnostic data in the obtained healthcare data according to the international classification of diseases, tenth revision, clinical modification. In one embodiment, processing the obtained healthcare data into the modified healthcare data set includes breaking the obtained healthcare data into a plurality of discrete segments, each segment associated with a unique value for a given attribute describing the obtained healthcare data.

The modified healthcare data set is processed through a plurality of separate analytic algorithms to generate an enriched healthcare data set that includes healthcare treatment outcome data, course of healthcare treatment data and predicted future healthcare costs for the given group of individuals. In one embodiment, processing the modified healthcare data set through the plurality of separate analytic algorithms further includes processing the modified healthcare data set using a disease identification algorithm configured to identify occurrences of diseases within the group of individuals, processing the modified healthcare data set using a disease severity algorithm configured to determine severity of the identified occurrences of diseases, processing the modified healthcare data set using an episode grouper algorithm configured to group data into episodes describing a complete course of care for a given medical condition and processing the modified healthcare data set using a gaps in care algorithm. In addition, the modified healthcare data set is processed using a healthcare cost prediction algorithm configured to generate predicted future healthcare costs. Each predicted future healthcare cost covers a prescribed future time horizon for a given individual in the group of individuals.

Each predicted future healthcare cost can be adjusted for inflation or based on demographic data for the given individual associated with that predicted future healthcare cost. In addition, the generated predicted future healthcare costs can be aggregated into an aggregate predicted future healthcare cost covering the group of individuals or truncated when the predicted future healthcare costs that exceed a prescribed maximum cost to the prescribed maximum cost. In addition to obtaining and processing healthcare data once, updated healthcare data loads can be obtained over time, and each predicted future healthcare cost is updated in response to each updated healthcare data load.

In one embodiment, the healthcare cost prediction algorithm is stochastic gradient boosted regression trees. A regression tree boosting statistical learning algorithm is used to iteratively fit a plurality of individual regression trees to administrative healthcare data containing historical medical claim data, pharmacy data, enrollment data and demographic data for a plurality of enrollees in a plurality of healthcare plans. The administrative healthcare data are separate from the obtained healthcare data. When using the regression tree boosting statistical learning algorithm, the administrative healthcare data is segmented into a training set and a separate testing set. Only the training set is used to fit the plurality of individual regressions trees to the administrative healthcare data, and only the testing set is used to evaluate the resulting regression trees. In addition, the administrative healthcare data is segmented into a training set and a separate validation set. The training set is used to fit the plurality of individual regression trees sequentially to the administrative healthcare data, and the validation set is used to check a fit between observed values in the validation set and predicted values generated by the plurality of individual regressions trees following the addition of each individual regression. The use of the training data to fit the plurality of individual regression trees is terminated when subsequent individual regression trees fail to improve the fit.

The enriched healthcare data set is stored in a database, and the stored enriched healthcare data set is used to generate and display reports comprising predicted healthcare expenditures for the given groups of individuals. In one embodiment, a query is received for a report containing at least one healthcare data analysis of the healthcare data, i.e., one type of enriched healthcare data, for a specified categorical sorting of the healthcare data. The relevant data are obtained from the enriched healthcare data set and are used to display the report containing the healthcare data analysis for the specified categorical sorting. In on embodiment, in the displayed report changes in the obtained relevant data are animated over a defined period of time that covers a future time horizon. In one embodiment, a query is received for a report containing two healthcare data analyses for the specified categorical sorting. The obtained relevant data are used to display the report as a two dimensional graph over the two healthcare data analyses.

Exemplary embodiments in accordance with the present invention are also directed to a system for predicting healthcare expenditures. This system includes s healthcare expenditure prediction service running on a computing system, in communication with at least one customer and configured to obtain healthcare data covering a given group of individuals associated with that customer over a predetermined period of time. The healthcare expenditure prediction service includes a data quality service configured to process the obtained healthcare data into a modified healthcare data set. The data quality service further includes at least one of a derived healthcare data attribute module configured to create derivative attributes from raw data in the obtained healthcare data, an aggregation module configured to aggregate the healthcare data, a discretization module configured segment the healthcare data and a cleansing module configured to identify and to eliminate errors in the healthcare data.

Also within the healthcare expenditure prediction service is an analytics engine that si in communication with the data quality service and that includes a plurality of separate analytic algorithms. The analytic algorithms are configured to process the modified healthcare data set to generate an enriched healthcare data set containing healthcare treatment outcome data, course of healthcare treatment data and predicted future healthcare costs for the given group of individuals. In one embodiment, the analytics engine includes at least one of a disease identification algorithm, a disease severity algorithm, an episode grouper algorithm, a gaps in care algorithm and a healthcare cost prediction algorithm containing a stochastic gradient boosted regression tree. A data warehouse is provided in communication with the analytics engine and includes a database configured to store the enriched healthcare data set in a database. The healthcare expenditure prediction service is configured to use the stored enriched healthcare data set to generate and display reports containing predicted healthcare expenditures for the given groups of individuals to the customer in response to queries received from the customer. In one embodiment, the health expenditure prediction service is also configured to animate the generated and displayed reports over a defined period of time covering a future time horizon.

### BRIEF DESCRIPTION OF THE DRAWINGS

FIG. 1 is an illustration of an embodiment of a system for providing predictive healthcare costs in accordance with the present invention;

FIG. 2 is a flow chart illustrating an embodiment of a method for providing predictive healthcare costs in accordance with the present invention;

FIG. 3 is an embodiment of a regression tree for use in predicting healthcare expenditures;

FIG. 4 is an embodiment of an animated graph displaying results of a healthcare expenditure prediction in accordance with the present invention; and

FIG. 5 is another embodiment of an animated graph displaying results of a healthcare expenditure prediction in accordance with the present invention.

### DETAILED DESCRIPTION

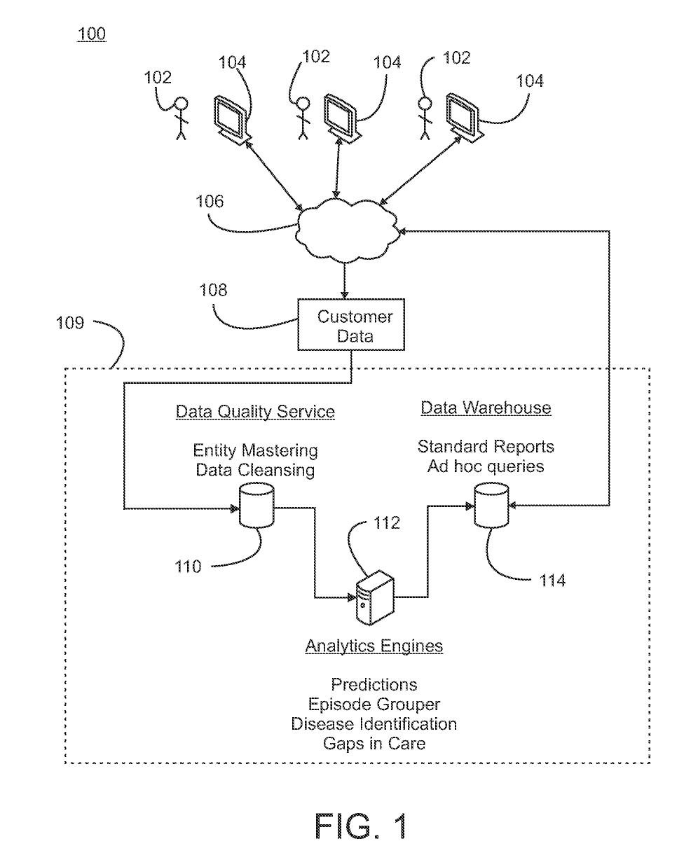

Referring initially to FIG. 1, an embodiment of a predictive healthcare system 100 for predicting healthcare expenditures in accordance with the present invention is illustrated. The predictive healthcare system includes one or more customers or users 102 of the system. These customers include individuals or organizations including both private and public or governmental organizations that have a need or desire to monitor healthcare expenditures for a given group of individuals such as employees, customers, clients, retirees or pensioners. Suitable customers include, but are not limited to, businesses in the payer, third party administrator (TPA), and broker industries. The customers can be part of a single organization or can represent a plurality of separate organizations.

Each customer 102 has an associated computing system 104 to monitor, control and store organization data including healthcare data. These customer-based computing systems are in communication with a healthcare expenditure prediction service 109 across one or more computer networks 106 including wide are networks and local area networks. Customer healthcare data 108 are transmitted from the customer computing systems 104 across the networks 106 to the healthcare expenditure prediction service 109. Suitable healthcare data includes, but is not limited to, cost data associated with claims made to healthcare plans covering individuals in a given group of individuals associated with a customer, demographic data, healthcare plan enrollment data, diagnosis data, chronic disease data, lab result data, electronic medical records, health risk assessments, pharmacy data, genomic data, national drug codes (NDC) for pharmacy data, the international classification of diseases, ninth revision, clinical modification (ICD-9-CM), the international classification of diseases, tenth revision, clinical modification (ICD-10-CM) and combinations thereof The customer obtained healthcare data includes both payer-centric claim data and provider-centric claim data. The healthcare data cover a predetermined period of time such as days, weeks, months or years. For example, the healthcare data can cover a previous one or two year period for a given customer or organization. The obtained healthcare data can also represent an ongoing download of healthcare data that is obtained weekly, monthly or quarterly.

The healthcare expenditure prediction service 109 includes a plurality of modules configured for receiving, storing and processing the customer obtained healthcare data and for generating reports that include, for example, predicted healthcare expenditures. These generated reports are communicated back to the customer-based computing systems across the networks 106. The healthcare expenditure prediction service can be configured as a distributed computing system or can be provided as a service on a single, autonomous computing system. In one embodiment, the healthcare expenditure prediction service is provided as a cloud computing service. Alternatively, the healthcare expenditure prediction service is provided as a computer-executable software application that is downloaded or instantiated on customer computing systems.

Within the healthcare expenditure prediction service 109 is a data quality service 110 that is configured to receive the obtained customer healthcare data, store that data and perform pre-processing on raw data in the customer data. Pre-processing of the data includes identification and removal of errors in the data and formatting or organizing the data as desired for subsequent analysis and report generation. The data quality service includes a derived healthcare data attribute module configured to create derivative attributes from raw data in the obtained healthcare data, an aggregation module configured to aggregate the healthcare data, a discretization module configured segment the healthcare data and a cleansing module configured to identify and to eliminate errors in the healthcare data. The data quality service outputs a modified healthcare data set. An analytics engine 112 is provided in communication with the data quality service. The analytics engine receives the modified healthcare data set. The analytics engine includes a plurality of separate analytic algorithms each configured to process and analyze at least a portion of the modified healthcare data set. These analytic algorithms include a disease identification algorithm, a disease severity algorithm, an episode grouper algorithm, a gaps in care algorithm and a healthcare cost prediction algorithm constructed as a stochastic gradient boosted regression tree. This results in an enriched healthcare data set that includes the results or outputs of the various analytic algorithms, for example, healthcare treatment outcome data, course of healthcare treatment data and predicted future healthcare costs.

The healthcare expenditure prediction service 109 also includes at least one data warehouse 14, including a database in communication with the analytics engine 112. The data warehouse stores the enriched healthcare data set and produces both standardized and custom reports in response, for example, to ad hoc queries from the customers. The data warehouse also includes animation capabilities to animate the reports provided to the customers. Suitable report animation capabilities are known and available in the art. The data warehouse is in communication with the customer based computing systems to receive queries and to deliver the reports and report animations. In general, the healthcare expenditure prediction service is arranged as a modular service such that components within the service can be removed, added or modified. Such modifications include adding additional or updated capabilities, modules and algorithms to the data quality service and the analytics engines.

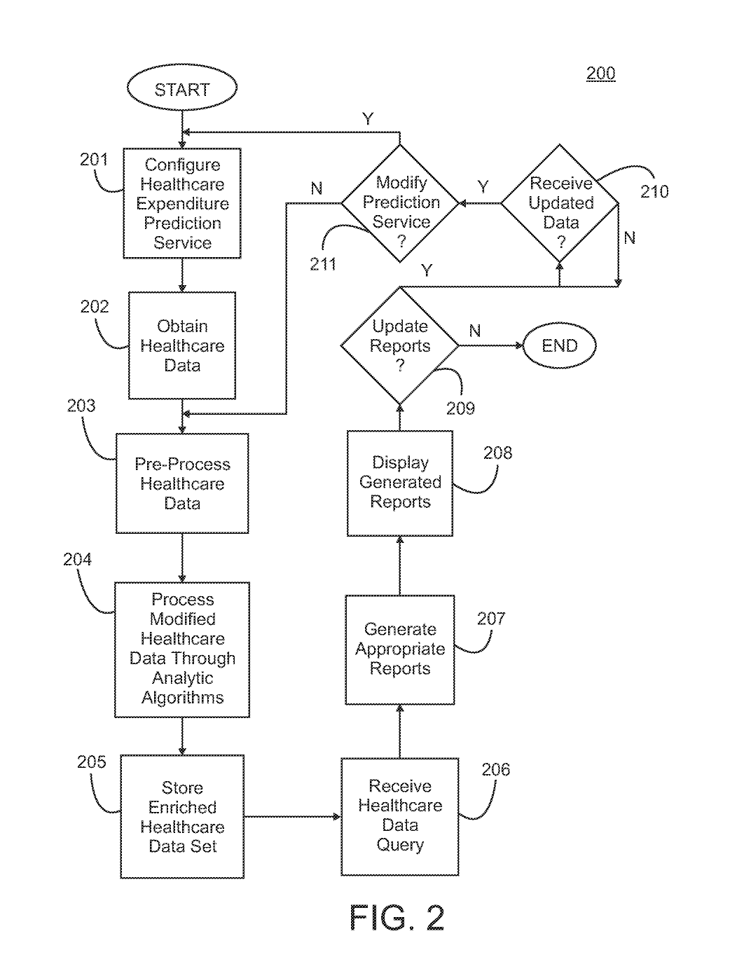

Referring to FIG. 2, exemplary embodiments in accordance with the present invention are also direct to a method 200 for predicting healthcare expenditures. In order to provide the desired future predictions of healthcare expenditures, all of the components of the healthcare expenditure prediction service are configured 201. This configuration includes the assembly of the healthcare data pre-processing components, the analytic algorithms, the report generators and the report animators. The pre-processing components are selected to detect errors in the obtained customer healthcare data, to organize the obtained healthcare data as desired for future processing including segmenting and categorizing the data and to create derived attributes from the obtained healthcare data. The desired pre-processing elements are identified and are grouped together to form a data quality service. Systems and methods in accordance with the present invention include McKesson's disease identification, gaps in care measures, and disease severity in the analytic algorithms used to process the modified healthcare data set. In addition, episode grouper identification results can be included in the analytic algorithms use to process the modified healthcare data in order to produce the predictive results. Episode groupers evaluate or mine the obtained healthcare data to identify sequences of patient care related to a given disease episode. Patient data, including inpatient and outpatient claims as well as pharmacy data are grouped together into units termed episodes that describe a complete course of treatment for a given individual for a given illness or condition. Gaps in care identifies gaps in health care that can save future medical costs and improve the outcomes in a given course of treatment. In particular, individuals in a given group of individual that are not receiving a recommended course of treatment for a given illness or condition are identified.

The various pre-processing elements can be applied in parallel or in sequence to the obtained healthcare data. The report generators are selected to either generate standard reports or to respond to ad hoc queries from customers. Suitable report animators are known and available in the art and provide visual animation of the generated reports.

The analytics algorithms are selected to generate the enriched data necessary for report generation. In one embodiment, a healthcare cost prediction algorithm is generated in order to process the obtained healthcare data and to generate the predictive healthcare expenditure data. This algorithm is created using a representative set of administrative healthcare data to create, train, test and validate the healthcare cost prediction algorithm. Once the healthcare cost prediction algorithm is created, it is then used to process the healthcare data obtained from the customers. In one embodiment, the present invention utilizes a machine learning approach for its predictive analytics. In particular, the data mining algorithm used to generate the healthcare cost prediction algorithm that will generate, for example, patient cost models using the obtained healthcare data utilizes stochastic gradient boosted regression trees (GBM). GBM is an example of an ensemble modeling approach. In accordance with the present invention, the ensemble model is a regression tree generated from a combination of a set of weak learners that are smaller individual decision trees. These weak learners, working together, yield healthcare expenditure prediction results that are better than using one large individual model.

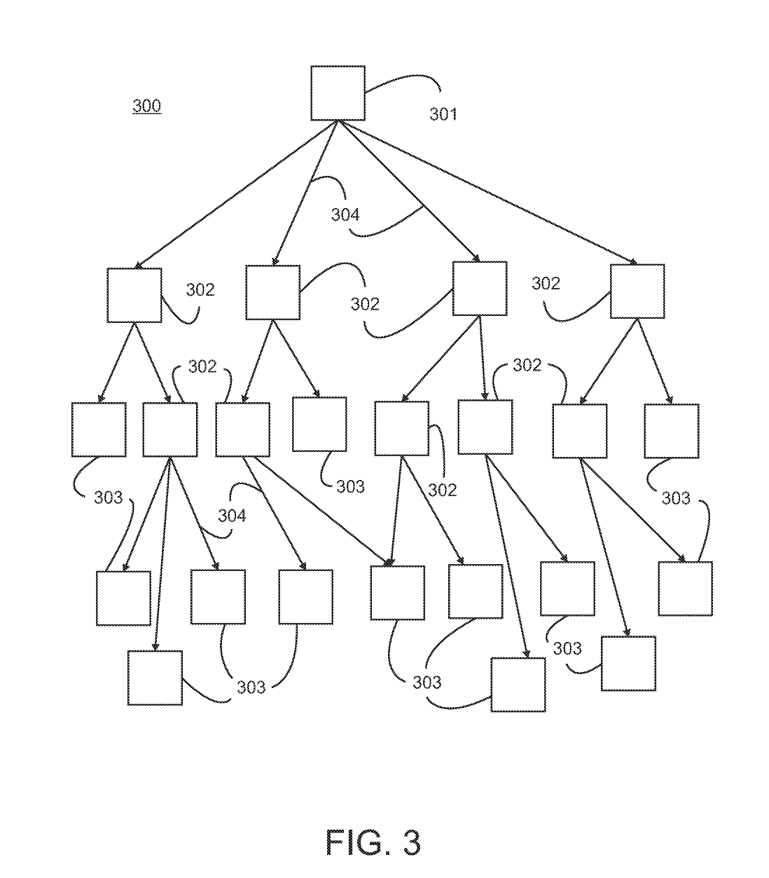

Ensemble models have proven to have state-of-the-art accuracy when applied to many types of predictions in the healthcare industry. An example of the use of regression tree boosting for predictions in the healthcare industry is John W. Robinson, “Regression Tree Boosting to Adjust Health Care Cost Predictions for Diagnostic Mix”, Health Service Research, 43(a), pages 755-772, April 2008, the entire content of which is incorporated herein by reference. Referring to FIG. 3, the result of regression tree boosting is a regression tree 300. In one embodiment, a single regression tree is created. Alternatively, a plurality of regression trees is generated. Each regression tree includes a root node 301, a plurality of intermediate nodes 302 and a plurality of terminal or leaf nodes 303. The root node and intermediate nodes are associated with variables and are used as decision point at which the tree splits. Suitable variables include, but are not limited to, demographic information, cost history, diagnosis data, pharmacy codes, chronic disease states and derived data. The lines or edges 304 between the nodes represent the values of the variables for a given decision point. For example, the decision point at the root node is the demographic data of age. The four lines extending from the root node represent the age ranges less than 20, 20 to 30, 30 to 50 and greater than 50. The terminal nodes represent the resultant data of the decision tree. In order to yield predictive healthcare costs, these resultant data are costs in dollars. By passing the obtained healthcare data through the regression tree, taking the appropriate edge from any given node, a predicted cost associated with the patient is generated. A single regression tree can be trained. Alternatively, a plurality of separate predictive regression trees is generated. For a given regression tree, weak learners are added until a point is reached where additional trees do not sufficiently improve the predictive fit of the overall regression tree.

The healthcare prediction algorithm in accordance with the present invention includes one or more of the resultant repression trees. The obtained healthcare data is then processed through the healthcare cost prediction algorithm to predict costs for individual patients or individuals within a given group of individuals from whom the healthcare data were obtained. The obtained healthcare data covers historical healthcare data for a given group of individuals over a given period of time to predict healthcare expenditures for these individuals over a pre-defined period of time in the future. For example, one year of prior year patient data is used to predict total costs, including pharmacy costs, for the following year.

The healthcare cost prediction algorithm model incorporates a broad range of healthcare related data including medical claim, pharmacy, healthcare plan enrollment and demographic data. In order to develop the regression tree of the healthcare cost prediction algorithm, administrative healthcare data is obtained from a large, research quality, healthcare database such as the MedStat data set, which is commercially available from Thompson Reuters Corporation of New York, N.Y. The MedStat administrative healthcare data set includes nearly three-quarters of a billion individual claim lines from medical claims, including inpatient, outpatient, and physician claims, and prescriptions, spanning a plurality of years, e.g., four years, 2006-2009. Approximately 12 million unique patients exist for each year. The MedStat data set is processed using GBM to generate one or more regression trees that are then used in the analysis of the customer obtained healthcare data. In one embodiment, the MedStat data set is also pre-processed for categorization, error detection, segmentation or derived attribute generation.

Over-training is a well-known risk of data mining models such as the healthcare cost prediction algorithm of the present invention. The effect of over-training a data mining model is that predictions made by the resultant healthcare cost prediction algorithm for newly submitted customer healthcare data are not as accurate as the results obtained from the administrative training data used to create the healthcare cost prediction algorithm. Exemplary embodiments of systems and methods in accordance with the present invention utilize state-of-the-art techniques to detect and evaluate potential over-training These techniques include segmentation of the administrative healthcare training data used to train or to create the healthcare cost prediction algorithm into separate training, validation and testing sets. In one embodiment, the administrative healthcare training data used to train or to develop the healthcare cost prediction algorithm is segmented into separate training and test sets. For example, about 70% of the healthcare cost administrative data are allocated for training, i.e., creating, the prediction algorithm, and about 30% of the administrative healthcare training data are allocation for testing the resultant prediction algorithm. The test data portion is never used for training and is only used for prediction algorithm evaluation. All prediction algorithm evaluation statistics are generated using data only from the test set. Descriptive statistics of the attributes used in the prediction algorithm show that the test sample is representative of the training set.

In addition to training and testing, the resultant prediction algorithm is validated in order to determine its general applicability to any given set of healthcare data. In one embodiment, multi-fold cross validation is used to evaluate the generalizability of the healthcare cost prediction algorithm generated using the administrative healthcare training data. For example, if the administrative healthcare training data is broken into ten partitions based on a given aspect of the administrative healthcare training data, i.e., demographics or disease type, ten healthcare cost prediction algorithms are created each with one tenth of the data removed as validation data. Therefore, the entire administrative healthcare data set is treated as validation data in estimating model performance. In addition to using a single general healthcare cost prediction algorithm or predicting overall healthcare expenditures, a plurality of targeting healthcare costs prediction algorithms can be used or a plurality of targeted predicted healthcare expenditures can be produced. This targeting can focus, for example, on specific diseases or disease categories, specific groups of individuals or patients such as neonatal patients, and specific healthcare treatment categories, for example pregnancy.

A given healthcare statistic associated with a given individual within a group of individuals can deviate substantially away from the normal values associated with that statistic for the entire group of individuals. However, there is a tendency for this healthcare statistic associated with the given individual to regress back to the normal values or population mean for that healthcare statistic. This tendency is referred to as regression to the mean. In one embodiment, regression to mean behavior for cost estimates is implicitly incorporated into the creation or training of the healthcare cost prediction algorithm by using supervised training, which implicitly incorporates regression to mean behavior for cost estimates. In addition, clinical attributes, e.g., diagnoses, prescription use, and chronic disease identification, as well as a prior cost behavior, are explicitly incorporated into the healthcare cost prediction algorithm, providing predictive value beyond simple prior probabilities. For example, two separate individuals or patients within a given group of individuals are of similar age and gender and have a similar total annual healthcare cost associated with them. A first patient includes a prior year diagnosis of pregnancy without complications, and the second patient has a diagnosis of asthma along with prescriptions for inhaled steroid use. The healthcare cost predictive algorithm in accordance with the present invention is able identify which patient is more likely to have costs which regress to the mean, and which will continue at an elevated level based on these associated qualities.

Model performance metrics are used to evaluate each resultant healthcare cost prediction algorithm developed in accordance with the present invention. One model performance metric is the R² statistic, which is commonly used to evaluate the performance of predictive models. The coefficient of determination, R², is the proportion of the variability in the healthcare data set that is accounted for by the healthcare cost prediction algorithm used to model or predict future healthcare costs. This variability is defined as the sum of squares. Therefore, R² provides a measure of how well future healthcare expenditures are likely to be predicted by the healthcare cost prediction algorithm that was created. For a data set containing observed values yᵢ, each of which has an associated predicted value fᵢ,μSSₑᵣᵣ and SSₜₒₜ are defined as follows:

Mean of observed values:

$$μ = \frac{1}{N} \times \sum {y}_{i} ;$$

Residual sum of square: SSₑᵣᵣ=Σ(yᵢ−fᵢ)²;

Total sum of squares: SSₜₒₜ=Σ(yᵢ−μ)²;

And the coefficient of determination is: R²=1−(SSₑᵣᵣ/SSₜₒₜ).

A second model performance metric is the mean average absolute error (MAE). The MAE measures the average magnitude of the errors in the set of future predicted healthcare costs, without considering the direction associated with those errors. The MAE is the average absolute difference in dollars between predicted and actual costs for the entire year. This is expressed by the following equation:

$$MAE = ( \frac{1}{N} ) \sum ( {y}_{i} - {f}_{i} ) .$$

A set of R² performance metrics were generated using the prediction results of an unseen out-of-sample population, i.e., a given set of healthcare data for a given group of individuals. Table 1 illustrates the coefficients of determination, R², for the given group of individuals or population at a range of claim truncation levels from $100K to $250K, which range from 31.8% to 29.9%. This compares to published results for top analytics providers, which are in the range of 25.4% to 32.1%.

TABLE 1
Coefficients of Determination

| Truncation Level | R² |
|---|---|
| 100K | 31.8% |
| 150K | 30.8% |
| 200K | 30.2% |
| 250K | 29.9% |

Additionally, performance metrics by cost range are provided to increase visibility into model capabilities across a range of patient costs. The cost ranges are defined as follows in Table 2:

TABLE 2
Cost Ranges

| Patients | | | | Mean of | Mean of | |
|---|---|---|---|---|---|---|
| in | | | Patient | Predicted | Actual | |
| Top % | Min ($) | Max ($) | Count | Cost ($) | Cost ($) | Ratio |
| 0 | 0 | 651 | 343,795 | 521.42 | 493.65 | 1.06 |
| 10 | 651 | 899 | 343,754 | 773.54 | 771.06 | 1.00 |
| 20 | 899 | 1,203 | 343,776 | 1,041.28 | 1,056.56 | 0.99 |
| 30 | 1,203 | 1,566 | 343,773 | 1,381.29 | 1,417.62 | 0.97 |
| 40 | 1,566 | 2,054 | 343,775 | 1,796.21 | 1,845.03 | 0.97 |
| 50 | 2,054 | 2,711 | 343,775 | 2,364.91 | 2,341.69 | 1.01 |
| 60 | 2,711 | 3,596 | 343,773 | 3,130.51 | 3,051.46 | 1.03 |
| 70 | 3,596 | 4,941 | 343,775 | 4,212.46 | 4,168.01 | 1.01 |
| 80 | 4,941 | 7,762 | 343,774 | 6,120.60 | 6,266.41 | 0.98 |
| 90 | 7,762 | 11,490 | 171,887 | 9,335.29 | 9,577.68 | 0.97 |
| 95 | 11,490 | 18,907 | 103,133 | 14,299.29 | 14,405.30 | 0.99 |
| 98 | 18,907 | 26,979 | 34,377 | 22,326.52 | 22,413.28 | 1.00 |
| 99 | 26,979 | 37,506 | 17,189 | 31,275.62 | 31,536.58 | 0.99 |
| 99.5 | 37,506 | 250,000 | 17,188 | 67,144.80 | 65,948.27 | 1.02 |

Systems and methods in accordance with the present invention utilize healthcare cost prediction algorithms that have an R² value within 7% of the best values publically published.

Returning to FIG. 2, having created and configured the healthcare expenditure prediction service, healthcare data, i.e., customer healthcare data, covering a given group of individuals over a predetermined period of time is obtained 202. A wide range of administrative healthcare data from customers is utilized. In addition to the administrative healthcare data obtained from customers, healthcare data can be obtained that includes additional, more clinically oriented healthcare attributes. These healthcare data can be obtained from lab results, electronic medical records (EMRs), and health risk assessments (HRAs). The obtained healthcare data used to predict healthcare expenditures as well as the administrative healthcare data used to create or to train the healthcare cost prediction algorithm are obtained from payer-centric data sets or provider-centric data sets spanning a broader range of age groups and plan types. In one embodiment, the healthcare data include cost data associated with claims made to healthcare plans covering individuals in the given group of individuals, demographic data, healthcare plan enrollment data, diagnosis data, chronic disease data, lab result data, electronic medical records, health risk assessments, pharmacy data, genomic data and combinations thereof.

Regarding pharmacy data, in one embodiment, the Thompson Reuters Red Book pharmacy reference, commercially available from Thompson Reuters Corporation of New York, N.Y., is used for aggregating drug data into hierarchies. Alternatively, the industry standard First Data Bank pharmacy reference data is used. The First Data Bank pharmacy reference is commercially available from First Data Bank of San Francisco, Calif. and provides a rich set of frequently updated pharmacy data including drug hierarchies, contra-indications, generic ingredient, and therapeutic use.

In one embodiment, the healthcare data include gene sequences or genetic mapping for individuals within the group of individuals associated with the obtained healthcare data. In one embodiment, the entire genome for one or more individuals is provided. This genetic information is used for identification of diseases, treatment regimes and pharmacy data that can guide healthcare professional in prevention and treatment of illness and provide for improved prediction and management of the associated costs. Healthcare data can be obtained from a single customer or a plurality of customers and can be processed in sequence or in parallel through the healthcare prediction service of the present invention.

Having obtained the healthcare data, the obtained healthcare data are pre-processed through the data quality service into a modified healthcare data set 203. Pre-processing of the obtained healthcare data includes identifying and eliminating errors in the obtained healthcare data. The obtained customer data undergoes a comprehensive cleansing and error identification process before using. In one embodiment, derivative healthcare attributes are created from raw data in the obtained healthcare data. These derivative healthcare attributes include, for example, a total healthcare cost over the predetermined period of time covered by the customer healthcare data, a maximum single healthcare cost over the predetermined period of time, an average healthcare cost over the predetermined period of time, a count of single healthcare expenditures above the average healthcare cost, a healthcare cost spike indicator, healthcare cost trends, a healthcare cost period ratio, healthcare costs per individual or combinations thereof These derived attributes help the prediction model recognize an individual's or patient's cost trajectory. For example, the cost spike indicator, measures whether a patient has one or more months with a cost greater than or equal to 3 standard deviations from the average cost for that patient. This indicator increases the ability of the decision tree to distinguish between chronic healthcare costs, which have a high likelihood of continuing in the future, and acute costs, which drop off.

Pre-processing of the obtained customer healthcare data also includes for example, aggregation or discretization, i.e., segmentation. These steps reduce sensitivity to variables that are administrative in nature, for example, differences in how healthcare providers code similar diagnoses. National drug codes for pharmacy data in the obtained healthcare data are aggregated according to the therapeutic class groupings defined in a given pharmacy reference, and diagnostic data in the obtained healthcare data are aggregated according to the international classification of diseases, clinical modification, ninth or tenth revision. Discretization breaks the obtained healthcare data into a plurality of discrete segments. Each segment associated with a unique value for a given attribute describing the obtained healthcare data. The resulting preprocessed data are organized, for example, as illustrated in Table 3.

TABLE 3
Summary of the types of data used in the
predictive model, grouped by type:

| Type | Description |
|---|---|
| Demographic | Age grouping, Gender, Geographic |
| | location (3-digit zip code and state) |
| Cost history | Total annual, count of above average, max, |
| | and average monthly cost, cost, spike |
| | indicator, cost trend over last 3 and 6 |
| | months, cost period ratios, individual |
| | quarterly costs |
| Diagnosis data | ICD-9 diagnosis codes grouped to Tabular |
| | List level 2 |
| Pharmacy codes | NDC codes grouped to the therapeutic |
| | class level |
| Chronic diseases | ICD-9 diagnosis are used to identify |
| states | chronic disease |

The modified healthcare data set is processed through a plurality of separate analytic algorithms 204 to generate an enriched healthcare data set. This enriched healthcare data set is suitable for use in generating reports and animations in response to customer queries and includes healthcare treatment outcome data, course of healthcare treatment data and predicted future healthcare costs for the given group of individuals on both a per individual and aggregate group cost. In one embodiment, the modified healthcare data set is processed using a disease identification algorithm configured to identify occurrences of diseases within the group of individuals, a disease severity algorithm configured to determine severity of the identified occurrences of diseases, an episode grouper algorithm configured to group data into episodes describing a complete course of care for a given medical condition or a gaps in care algorithm. In one embodiment, the modified healthcare data set is processed using the healthcare cost prediction algorithm that is configured to generate predicted future healthcare costs. Each predicted future healthcare cost covers a prescribed future time horizon for a given individual in the group of individuals. For example, the prescribed future time horizon can equal the predetermined period of time covered by the obtained healthcare data.

In one embodiment, the output of the healthcare cost prediction algorithm is the total cost (US$), including both medical and pharmacy costs, for a prescribed future time horizon, e.g., 12 months, for a given individual or patient in the group of individuals. The cost predictions are inflation adjusted. In one embodiment, the formula used to calculate a given patient's inflation-adjusted cost is Patient Predicted Cost=nationally representative cost prediction+inflation adjustment. In one embodiment, the healthcare cost prediction algorithm produces a predictive future model of healthcare expenditures and automatically adjusts these expenditures for inflation. A baseline inflation assumption is incorporated into the algorithm, for example a 7% cost increase per year. The predictive healthcare costs are also adjusted for cost variation related to demographic factors for an individual associated with a given predicted healthcare cost. Suitable demographic factors include, but are not limited to, a three-digit zip code identifier associated with individuals or patients and geographic location such as state. In one embodiment, customers specify the three-digit zip code which best reflects their group's data.

In one embodiment, the predicted future healthcare costs are generated on a per individual basis. Healthcare cost predictions covering an entire group of individuals are calculated as the sum of each prediction for each individual or member in the group. Aggregating individual costs yields a more accurate group prediction than modeling costs at the group level directly. The aggregate predicted future healthcare cost covers the group of individuals.

A cost outlier is an example of an individual having an anomalous or rare medical experience. Typically, the costs associated with these anomalous circumstances are unusually high and above a certain level are essentially unpredictable. In one embodiment, the healthcare cost prediction algorithm is tuned to handle a given level or given maximum level of healthcare costs for a particular period of time, for example 12 months. The accuracy of the costs predictions, however, can decrease or become unreliable above a certain level. Therefore, the predicted future healthcare costs for each individual are truncated or capped at this level. In one embodiment, this level is about $200,000 per individual in a given 12 month period. These predictions are still subject to an upward inflation adjustment. In one embodiment, all predicted future healthcare costs that exceed a prescribed maximum cost are truncated to the prescribed maximum cost.

Once generated through the analytic algorithms, the enriched healthcare data set is stored in a database 205. As queries are received 206, the stored enriched healthcare data set is used to generate reports 207. These reports include predicted healthcare expenditures for the given groups of individuals and can be standardized reports or reports in response to ad hoc queries from customers. In one embodiment, the healthcare data are obtained from a given customer, e.g., a payer responsible for healthcare costs of the group of individuals, and the reports are generated in response to queries from that customer. In one embodiment, a query is received for a report that includes at least one healthcare data analysis for a specified categorical sorting of the healthcare data. The relevant data are obtained from the enriched healthcare data set, and the report is generated using the obtained relevant data for the specified categorical sorting.

The generated reports are displayed 208 to the requesting customer. Exemplary embodiments in accordance with the present invention provide for the mining of relevant enriched healthcare data, the generation of reports based on the mined data and the display of these reports in a format that is easy for the customer to understand and that eliminates the need for the customer to read through or analyze lengthy or complex data. In one embodiment, the generated reports containing the obtained relevant data are animated. Therefore, changes in the obtained relevant data are illustrated over a defined period of time, for example, a future time horizon. Suitable applications for animating reports are known and available in the art. In one embodiment, a query is received for a report based on two or more two types of healthcare data analyses for a specified categorical sorting of the enriched healthcare data set. The analyses are the outputs from any one of the analytic algorithms used to process the modified healthcare data. Suitable categorical sorting includes sorting by demographics, a sorting by geographic location, a sorting by healthcare service provider, a sorting by individual or a sorting by disease. In one embodiment, the report is displayed as a two dimensional graph with the two dimensions correspond to the two types healthcare data analyses.

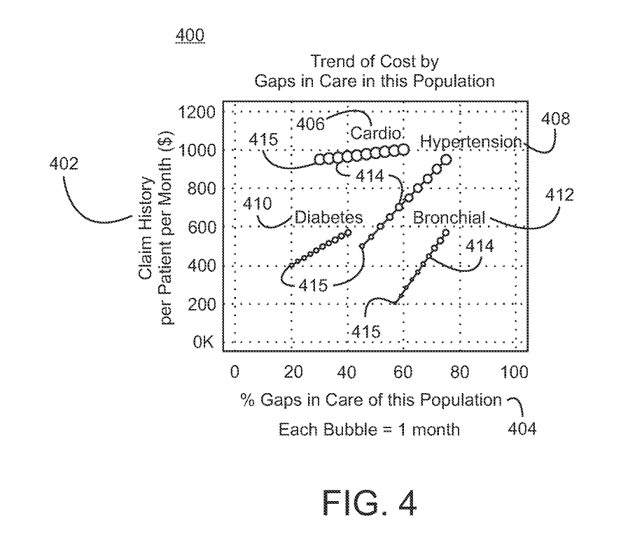

Referring to FIG. 4, an exemplary embodiment of a displayed report 400 in accordance with the present invention is illustrated. The displayed report illustrates the trend of costs by gaps in care for the patient population associated with the healthcare data. The displayed report is a two-dimensional graph of claim history per patient per month in dollars 402 versus the percent gaps in care of the given population 404, i.e., the group of individuals associated with the obtained healthcare data. These two dimensions represent the two types of healthcare data analysis. In addition, a separate trend line is shown for each one of a plurality of categorical sortings. As illustrated, the sortings are by diagnosis or disease and include a separate trend line for cardio 406, hypertension, 408, diabetes, 410 and bronchial 412. Each trend line is constructed from a plurality of points 414, illustrated as bubbles. Each bubble corresponds to one month of data. The bubbles can be of uniform size, fill and color or the size, fill and color can change along the trend line. In one embodiment, the customer is presented with the illustrated graph as shown. Alternatively, the graph is animated. When animated, the graph initially displays only the first bubble 415 for each separate trend line. Additional bubbles are then added sequentially to animate the trends over time.

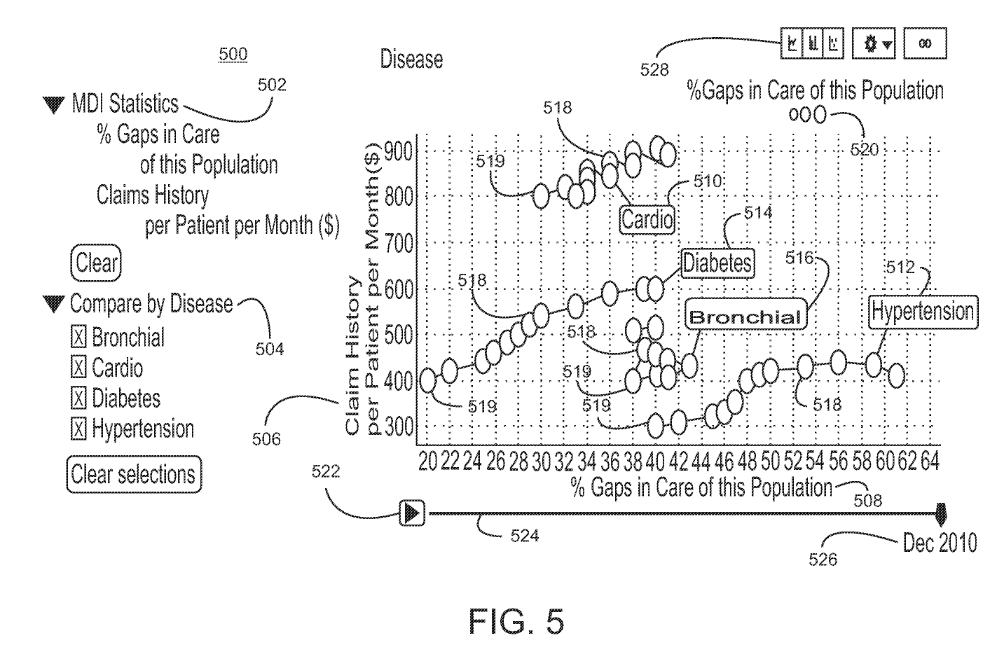

Referring to FIG. 5, a graphical user interface 500 for requesting the desired report, i.e., for submitting a query, and for animating the requested report is illustrated. The illustrated report is a two-dimensional graph, and selection windows are provided for the generated statistics 502 to be used for each axis of the graph and for the categorical sortings 504 to be compared by the trend lines. Again, the displayed report is a two-dimensional graph of claim history per patient per month in dollars 506 versus the percent gaps in care of the given population 508, i.e., the group of individuals associated with the obtained healthcare data. A separate trend line is shown for each one of a plurality of categorical sortings. As illustrated, the sortings are by diagnosis or disease and include a separate trend line for cardio 510, hypertension, 512, diabetes 514 and bronchial 516. Each trend line is constructed from a plurality of points 518. Each point corresponds to one month of data, and an interface is provided 520 to change the size of these points. An animation or play button 522 is provided to initiate animation of the desired report. The graph initially just displays the first bubble 519 for each separate trend line, and then additional bubbles are added sequentially to animate the trends over time. A time line 524 is provided to show the progress of the animation along with a progress indicator 526 showing the current time of the animation. A plurality of additional function button 528 is also provided to facilitate the selection of additional options including the type of graph or animation desired. Alternatives to the graphical interface are possible including the specific interfaces provided to select the axis values, sorting comparisons, trend line formats and the dimensionality of the graph.

Returning again to FIG. 2, the creation and display of reports can be processed as a single pass. Alternatively, updated healthcare data loads are obtained from a given customer over time, and each predicted future healthcare cost or other requested and displayed report is updated in response to each updated healthcare data load. An initial determination is made regarding whether updated or ongoing reports are desired 209. If not, the method terminates. If updated healthcare data is to be received, then the present invention monitors for the receipt of the updated data 210. The obtained healthcare data can be updated with additional data, for example on an ongoing weekly, monthly, quarterly or yearly basis. Once new or updated healthcare data are obtained, a check is made regarding whether or not the healthcare expenditure prediction service is to be modified 211. These modifications include updates or changes to the configuration of the data quality service or the analytic algorithms. If changes are to be made, the method returns to configuring the healthcare expenditure prediction service. If no updates are required, the newly obtained healthcare data is pre-processed and processed through the plurality of analytic algorithms. This will have an affect on any cost prediction. Therefore, prediction costs are recalculated with every data load. Customers loading data more frequently, e.g., weekly or daily, will see immediate updates to cost predictions. This can enable customers to take timely action with individuals or patients who have experienced an important acute event or new serious diagnosis.

Methods and systems in accordance with exemplary embodiments of the present invention can take the form of an entirely hardware embodiment, an entirely software embodiment or an embodiment containing both hardware and software elements. In one embodiment, the present invention is directed to a machine-readable or computer-readable medium including a non-transitory computer-readable medium containing a machine-executable or computer-executable code that when read by a machine or computer causes the machine or computer to perform a method for predicting healthcare expenditures in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of exemplary aspects of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of exemplary aspects of the present invention.

What is claimed is:

1. A method for predicting healthcare expenditures, the method comprising:
obtaining healthcare data covering a given group of individuals over a predetermined period of time;
processing the obtained healthcare data into a modified healthcare data set;
processing the modified healthcare data set through a plurality of separate analytic algorithms to generate an enriched healthcare data set comprising healthcare treatment outcome data, course of healthcare treatment data and predicted future healthcare costs for the given group of individuals;
storing the enriched healthcare data set in a database; and
using the stored enriched healthcare data set to generate and display reports comprising predicted healthcare expenditures for the given groups of individuals.

2. The method of claim 1, wherein the healthcare data comprises cost data associated with claims made to healthcare plans covering individuals in the given group of individuals, demographic data, healthcare plan enrollment data, diagnosis data, chronic disease data, lab result data, electronic medical records, health risk assessments, pharmacy data, genomic data or combinations thereof.

3. The method of claim 1, wherein the step of processing the obtained healthcare data into the modified healthcare data set further comprises creating-derivative healthcare attributes from raw data in the obtained healthcare data, the derivative healthcare attributes comprising a total healthcare cost over the predetermined period of time, a maximum single healthcare cost over the predetermined period of time, an average healthcare cost over the predetermined period of time, a count of single healthcare expenditures above the average healthcare cost, a healthcare cost spike indicator, healthcare cost trends, a healthcare cost period ratio, healthcare costs per individual or combinations thereof.

5. The method of claim 1, wherein the step of processing the obtained healthcare data into the modified healthcare data set further comprises aggregating national drug codes for pharmacy data in the obtained healthcare data according to the therapeutic class groupings defined in a given pharmacy reference, aggregating diagnostic data in the obtained healthcare data according to the international classification of diseases, ninth revision, clinical modification or aggregating diagnostic data in the obtained healthcare data according to the international classification of diseases, tenth revision, clinical modification.

6. The method of claim 1, wherein the step of processing the obtained healthcare data into the modified healthcare data set further comprises breaking the obtained healthcare data into a plurality of discrete segments, each segment associated with a unique value for a given attribute describing the obtained healthcare data.

7. The method of claim 1, wherein the step of processing the modified healthcare data set through the plurality of separate analytic algorithms further comprises processing the modified healthcare data set using a disease identification algorithm configured to identify occurrences of diseases within the group of individuals, processing the modified healthcare data set using a disease severity algorithm configured to determine severity of the identified occurrences of diseases, processing the modified healthcare data set using an episode grouper algorithm configured to group data into episodes describing a complete course of care for a given medical condition or processing the modified healthcare data set using a gaps in care algorithm.

8. The method of claim 1, wherein the step of processing the modified healthcare data set through the plurality of separate analytic algorithms further comprises processing the modified healthcare data set using a healthcare cost prediction algorithm configured to generate predicted future healthcare costs, each predicted future healthcare cost covering a prescribed future time horizon for a given individual in the group of individuals.

9. The method of claim 8, wherein step of processing the modified healthcare data set further comprises at least one of adjusting each predicted future healthcare cost for inflation, adjusting each predicted future healthcare cost based on demographic data for the given individual associated with that predicted future healthcare cost, aggregating the generated predicted future healthcare costs into an aggregate predicted future healthcare cost covering the group of individuals and truncating all predicted future healthcare costs that exceed a prescribed maximum cost to the prescribed maximum cost.

10. The method of claim 8, wherein the method further comprises obtaining updated healthcare data loads over time and the step of processing the modified healthcare data set further comprises updating each predicted future healthcare cost in response to each updated healthcare data load.

11. The method of claim 8, wherein:
the healthcare cost prediction algorithm comprises stochastic gradient boosted regression trees; and
the method further comprises using a regression tree boosting statistical learning algorithm to iteratively fit a plurality of individual regression trees to administrative healthcare data comprising historical medical claim data, pharmacy data, enrollment data and demographic data for a plurality of enrollees in a plurality of healthcare plans, the administrative healthcare data separate from the obtained healthcare data.

12. The method of claim 11, wherein the step of using the regression tree boosting statistical learning algorithm further comprises:
segmenting the administrative healthcare data into a training set and a separate testing set;
using only the training set to fit the plurality of individual regressions trees to the administrative healthcare data; and
using only the testing set to evaluate the resulting regression trees.

13. The method of claim 11, wherein the step of using the regression tree boosting statistical learning algorithm further comprises:
segmenting the administrative healthcare data into a training set and a separate validation set;
using the training set to fit the plurality of individual regression trees sequentially to the administrative healthcare data;
using the validation set to check a fit between observed values in the validation set and predicted values generated by the plurality of individual regressions trees following the addition of each individual regression; and
terminating the use of the training data to fit the plurality of individual regression trees when subsequent individual regression trees fail to improve the fit.

14. The method of claim 1, wherein the step of using the stored enriched healthcare data set to generate and display reports further comprises:
receiving a query for a report comprising at least one healthcare data analysis for a specified categorical sorting of the healthcare data;
obtaining relevant data from the enriched healthcare data set;
using the obtained relevant data to display the report containing the healthcare data analysis for the specified categorical sorting; and
animating in the displayed report changes in the obtained relevant data over a defined period of time comprising a future time horizon.

15. The method of claim 14, wherein the step of receiving the query further comprises receiving a query for a report comprising two healthcare data analyses for the specified categorical sorting and the step of using the obtained relevant data further comprises using the obtained relevant data to display the report as a two dimensional graph comprising the two healthcare data analyses.

16. A system for predicting healthcare expenditures, the system comprising:
a healthcare expenditure prediction service running on a computing system, in communication with at least one customer and configured to obtain healthcare data covering a given group of individuals associated with that customer over a predetermined period of time, the healthcare expenditure prediction service comprising:
a data quality service configured to process the obtained healthcare data into a modified healthcare data set;
an analytics engine in communication with the data quality service and comprising a plurality of separate analytic algorithms, the analytic algorithms configured to process the modified healthcare data set to generate an enriched healthcare data set comprising healthcare treatment outcome data, course of healthcare treatment data and predicted future healthcare costs for the given group of individuals; and
a data warehouse in communication with the analytics engine and comprising a database configured to store the enriched healthcare data set;
wherein the healthcare expenditure prediction service is further configured to use the stored enriched healthcare data set to generate and display reports comprising predicted healthcare expenditures for the given groups of individuals to the customer in response to queries received from the customer.

17. The system of claim 16, wherein the data quality service further comprises at least one of a derived healthcare data attribute module configured to create derivative attributes from raw data in the obtained healthcare data, an aggregation module configured to aggregate the healthcare data, a discretization module configured segment the healthcare data and a cleansing module configured to identify and to eliminate errors in the healthcare data.

18. The system of claim 16, wherein the analytics engine further comprises at least one of a disease identification algorithm, a disease severity algorithm, an episode grouper algorithm, a gaps in care algorithm and a healthcare cost prediction algorithm comprising a stochastic gradient boosted regression tree.

19. The system of claim 16, wherein the health expenditure prediction service is further configured to animate the generated and displayed reports over a defined period of time comprising a future time horizon.

20. A computer readable medium containing a computer executable code that when read by a computer causes the computer to perform a method for predicting healthcare expenditures, the method comprising:
obtaining healthcare data covering a given group of individuals over a predetermined period of time;
processing the obtained healthcare data into a modified healthcare data set;
processing the modified healthcare data set through a plurality of separate analytic algorithms to generate an enriched healthcare data set comprising healthcare treatment outcome data, course of healthcare treatment data and predicted future healthcare costs for the given group of individuals;
storing the enriched healthcare data set in a database; and
using the stored enriched healthcare data set to generate and display reports comprising predicted healthcare expenditures for the given groups of individuals.
